(19) United States
(12) Patent Application Publication
(10) Pub. No.: US 2022/0275770 A1
(43) Pub. Date: Sep. 1, 2022

(54) CYLINDER HEAD COVER

(71) Applicant: Mahle International GmbH, Stuttgart (DE)

(72) Inventors: Tilo Hentschel, Hattenhofen (DE); Justus Himstedt, Stuttgart (DE); Antonio Menonna, Ditzingen (DE); Luis Neumann, Schorndorf (DE); Katrin Schindele, Baiersbronn (DE)

(21) Appl. No.: 17/681,770

(22) Filed: Feb. 26, 2022

(30) Foreign Application Priority Data
Feb. 26, 2021 (DE) 102021201823.8

(51) Int. Cl. F02F 11/00; F01M 11/04; F01M 13/04; F01L 1/047

(52) U.S. Cl. CPC F02F 11/002; F01M 11/04; F01M 13/0416; F01L 1/047; F01L 2001/0476; B29C 45/14

(57) ABSTRACT

A cylinder head cover for covering a cylinder head of an internal combustion engine having at least one first sealing surface via which the cylinder head cover can be tightly connected to an associated second sealing surface on the cylinder head, the cylinder head cover may include at least one first reference surface configured for unambiguous position-fixing on an associated second reference surface of the cylinder head. The at least one first reference surface and the at least one first sealing surface may be formed separately from one another.

### CROSS-REFERENCE TO RELATED APPLICATION

This application claims priority to German Patent Application No. DE102021201823.8, filed on Feb. 26, 2021, the contents of which is hereby incorporated by reference in its entirety.

### TECHNICAL FIELD

The present invention relates to a cylinder head cover for covering a cylinder head of an internal combustion engine according to the preamble of claim 1. In addition, the invention relates to a cylinder head and to an internal combustion engine having such a cylinder head and such a cylinder head cover.

### BACKGROUND

Cylinder head covers close off a cylinder head towards the top and protect upper actuating elements of a valve drive from dirt and additionally prevent lubricating oil leaking out. The mounting of the cylinder head cover, which can be produced for example from aluminium and/or from plastic, is decisive in part for a function of an internal combustion engine later on in particular when the cylinder head cover additionally takes over, at least in parts, a mounting of a camshaft. Here, the tolerances to be established during the working of the cylinder head and of the cylinder head cover play a decisive role. In order to enforce a preferably exact relative position between the cylinder head cover and the cylinder head so-called reference surfaces are provided via which the cylinder head cover is connected to the cylinder head. At the same time, these reference surfaces constitute sealing surfaces between the cylinder head cover and the cylinder head, between which, under certain conditions, a seal for sealing the cylinder head is additionally arranged.

However, it is disadvantageous with known cylinder head covers that for achieving a highly precise reference surface, which represents the sealing surface at the same time, the sealing surfaces have to be highly precisely worked with respect to the dimensional tolerances, which is only possible to a limited degree and/or only with major expenditure. Because of the higher manufacturing effort brought about by the reworking of the sealing surfaces acting as reference surfaces at the same time, the manufacture of such cylinder head covers is comparatively elaborate and thus expensive. The high dimensional accuracy and the low allowed dimensional tolerances in the region of the sealing surfaces serving as reference surfaces however are necessary in order to be able to ensure an unambiguously predefined position of a camshaft relative to associated cam-followers.

The present invention therefore deals with the problem of stating for a cylinder head of the generic type an improved or at least an alternative embodiment which overcomes in particular the disadvantages known from the prior art.

### SUMMARY

The present invention is based on the general idea of decoupling, on a cylinder head cover known per se, the reference surfaces or at least one such reference surface from a sealing surface for the first time and connecting, for example screwing, the cylinder head cover to a cylinder head directly via the reference surfaces. By way of this it is possible to allow greater dimensional tolerances in the region of the sealing surface of the cylinder head cover, to obtain an improved vibration behaviour and a noise reduction and make possible a significantly improved alignment of a camshaft relative to cam-followers. Here, the cylinder head cover according to the invention for covering a cylinder head of an internal combustion engine possesses at least one first sealing surface, via which the cylinder head cover, with an associated second sealing surface, can be tightly connected to the cylinder head. According to the invention, at least one first reference surface is now provided on the cylinder head cover for the unambiguous position-fixing on an associated second reference surface of the cylinder head, wherein this at least one first reference surface and the at least one first sealing surface are formed separately from one another and thus decoupled relative to one another. By decoupling the first sealing surface of the cylinder head cover from the first reference surface, the following decisive advantages can be achieved:

For example, a working of the first sealing surface can thus be carried out with greater tolerances and thus more cost-effectively or be even omitted entirely. A further advantage is that the seal during the mounting of the cylinder head cover on the cylinder head is not included in the overall tolerance. By producing the at least one first reference surface with comparatively low tolerances an increased precision between a camshaft axis and a cam-follower axis and thus between the camshaft and the cam-followers, for example rocker arms, can be achieved. In addition, a close and thus function-appropriate connection, for example screw connection, of the cylinder head cover is possible, which has a positive effect on the absorption of engine forces and vibration behaviour. By way of this, a significantly reduced noise emission can be additionally achieved. In addition, the use of a cost-effective elastomer seal can also be made possible which, if applicable, can compensate for greater dimensional inaccuracies that may occur on the first sealing surface. In addition, a reduced number of connecting points, in particular of screw-on points, of the cylinder head cover to the cylinder head can be achieved, as a result of which a lower number of connecting means, such as for example screws and connected with this a lower warehouse and logistical expenditure and thus lower mounting costs are possible.

In an advantageous further development of the solution according to the invention, the at least one first reference surface is smaller than the at least one first sealing surface. This offers the great advantage that a reworking of the at least one first reference surface that may have to be performed for example is more cost-effectively possible because of the smaller surface, than has been possible to date with the comparatively large first sealing surface. Because of the smaller first reference surface and the lower tolerances of the same, a higher precision between a camshaft axis and a cam-follower axis and thereby a significantly better operation of a valve drive of the internal combustion engine can be additionally achieved. Through the more exact alignment of the camshaft axis relative to the cam-follower axis, a friction and thus a fuel consumption as well as a noise emission can also be reduced.

With a particularly advantageous embodiment of the cylinder head cover according to the invention, a sum of all first reference surfaces on the cylinder head cover is smaller than a sum of all first sealing surfaces. Thus, when the cylinder head cover according to the invention is connected via multiple first reference surfaces to multiple associated second reference surfaces of the cylinder head, a lower working effort and thus lower manufacturing costs are nevertheless still possible because of the smaller total surface area of the first reference surfaces compared with the first sealing surface. Here, the cylinder head cover can be positively connected to the cylinder head via its first reference surfaces.

In an advantageous further development of the cylinder head cover according to the invention, at least two first reference surfaces are provided which are oriented inclined relative to one another. By way of such inclined first reference surfaces and inclined second reference surfaces formed complementarily thereto and arranged on the cylinder head, an unambiguous, positive-locking attachment position of the cylinder head cover on the cylinder head can be enforced with which an exact parallel alignment of a camshaft axis relative to a cam-follower axis already materialises. Obviously, this requires that the camshaft is at least partly mounted in the cylinder head cover.

Practically, at least two bearings for a camshaft are provided on the cylinder head cover, wherein on at least bearing a first reference surface is arranged. Here, the bearings can be formed as split bearings, wherein a first bearing half-shell is integrally formed with the cylinder head cover, while a second bearing half-shell is connected, for example screwed to the first bearing half-shell and thus to the cylinder head cover. Obviously it is also conceivable that at least one bearing is formed as one-piece bearing on the cylinder head cover and preferentially in one piece with the cylinder head cover. Because of the circumstance that on at least one bearing a first reference surface is arranged, a connecting of the cylinder head cover to the cylinder head close to the camshaft can be achieved, as a result of which engine forces can be better absorbed and a vibration behaviour optimised. In addition, a reduced noise radiation is also possible by way of this.

Purely theoretically it is obviously also conceivable that the at least two bearings are part of a bearing frame that is connected to the cylinder head cover or integrally formed with the same. By way of such a bearing frame, an exact mounting of the camshaft or of the camshafts is made possible, wherein by way of a bearing frame that is formed separately and connected to the cylinder head cover a different choice of material for on the one hand the bearing frame and on the other hand the cylinder head cover is additionally possible. Accordingly, the bearing frame can be formed for example of metal while the cylinder head cover is formed of plastic. In this case, injection-moulding the cylinder head cover to the bearing frame is also possible. Alternatively it is conceivable that the cylinder head cover is formed as a plastic injection-moulding, wherein the at least two bearings comprise bearing rings, in particular of aluminium, which are injection-moulded into the plastic of the cylinder head cover or over moulded by the same.

In an advantageous further development of the solution according to the invention, the at least one first sealing surface is arranged parallel to a first sealing surface and surface-orthogonally spaced apart from the at least one first reference surface. Thus, the first reference surface can lie at a height level distinct from the first sealing surface, wherein it is obviously also conceivable that multiple first reference surfaces are provided which are each arranged at different height levels. By way of this, a positive connecting of the cylinder head cover to the cylinder head that is improved even further is possible.

Practically, the first sealing surface is formed flat or comprises a sealing groove for receiving a seal. With the sealing surface according to the invention, an alignment of the cylinder head cover relative to the cylinder head is brought about by way of the at least one first reference surface which is why with the first sealing surface greater dimensional tolerances are acceptable. In addition to this, an individual configuration to suit requirements of the first sealing surface for example for using ring seals, liquid seals or metal gaskets, which require or prefer different sealing surfaces, is also possible.

In a further advantageous embodiment of the cylinder head cover according to the invention, the same is formed as a metallic die-casting, for example of aluminium, or as an injection-moulding. Both embodiments make possible not only a cost-effective but also a weight-optimised and high-quality production. In particular the design as a plastic injection-moulding offers a particularly cost-effective production possibility. Because of the design as a plastic injection-moulding or as a metallic die-casting it is additionally possible to provide at least one opening on the cylinder head cover for example for installing a function component such as in particular of a position sensor, of a pump or of an oil mist separator or for filling-in oil.

Further, the present invention is based on the general idea of equipping a cylinder head of an internal combustion engine with at least one second sealing surface, via which the cylinder head can be tightly connected to an associated first sealing surface of a cylinder head cover described in the preceding paragraphs, wherein on the cylinder head cover at least one second reference surface for the unambiguous position-fixing on an associated first reference surface of the cylinder head cover is provided and wherein the at least one second reference surface and the at least one second sealing surface are formed separately from one another. By way of this, a cylinder head can be created which, by way of second reference surfaces decoupled from second sealing surfaces, can be coupled to a cylinder head cover described in the preceding paragraphs, wherein through the separation of the second reference surfaces from the second sealing surfaces a reduction of the noise development and an improved absorption of engine forces is possible. Through the separation of the second sealing surfaces from the second reference surfaces a greater dimensional inaccuracy on the second sealing surfaces can also be tolerated, as a result of which in particular the exact working of the same or generally a working of the second sealing surfaces can be omitted. For the exact mounting of the cylinder head cover with the camshaft mounted thereon only the second reference surfaces are now decisive, the smaller surfaces of which allow a reduced working, in particular a shorter working time.

In an advantageous further development of the cylinder head according to the invention, the same comprises at least two reference surfaces that are inclined towards one another. By way of likewise inclined first reference surfaces of a cylinder head cover formed complementarily thereto a positively and unambiguously predetermined position of the cylinder head cover relative to the cylinder head and thereby also a simple but exactly parallel position of the camshaft and its camshaft axis arranged on the cylinder head cover relative to the cam-follower axis predetermined by the cylinder head can thus be achieved. Because of the parallel mounting, a valve drive can be operated with lower friction and higher precision and thus the internal combustion engine with lower fuel consumption and lower noise emission.

Further, the present invention is based on the general idea of stating an internal combustion engine having a cylinder head and a cylinder head cover described in the preceding paragraphs that is connected to the said cylinder head. By way of this it is not only a cost-effective production of the internal combustion engine because of reference surfaces reduced in size that is possible but also an improved absorption of engine forces, an optimised vibration behaviour and a lower noise emission. Through the decoupling of the first reference surface(s) according to the invention from the first sealing surface(s) on the cylinder head cover and the associated second reference surface(s) and the second sealing surface(s) on the cylinder head at the same time, the first and second sealing surface can also be produced with greater dimensional tolerances which, for example by using elastomer seals, can compensated for without problems.

On its at least one first reference surface the cylinder head cover is screwed, glued, riveted and/or connected via dowels to an associated second reference surface on the cylinder head. Even this non-conclusive enumeration gives rise to the assumption of the manifold connection possibilities between the cylinder head cover according to the invention and the cylinder head that exist. Between the first sealing surface and the associated second sealing surface an elastomer seal, a paper gasket, a liquid seal or a metal gasket can be arranged. Through the decoupling of the reference surfaces from the sealing surfaces according to the invention, elastomer seals can also be employed for example which allow greater dimensional tolerances on the first and second sealing surfaces since an alignment of the cylinder head cover relative to the cylinder head no longer takes place via the sealing surface but now via the reference surfaces decoupled from the same.

In an advantageous further development of the internal combustion engine according to the invention, the cylinder head cover comprises at least two first reference surfaces inclined towards one another, wherein on the cylinder head at least two inclined second reference surfaces that are formed complementarily to the inclined first reference surfaces arranged on the cylinder head cover are arranged, and wherein the cylinder head cover and the cylinder head are positively connected to one another via the at least two first and second reference surfaces. By way of the inclined first and second reference surfaces, a positive connection between the cylinder head and the cylinder head cover can thus be established which already enforces a predefined parallelism between a camshaft axis and a cam-follower axis. By way of this, a simple but high-quality mounting can be achieved at the same time.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIG. 1 a sectional representation through an internal combustion engine having a cylinder head cover and a cylinder head according to the prior art,

FIG. 2 a sectional representation through a cylinder head cover according to the invention and a cylinder head according to the invention,

FIG. 3 a lateral view of the cylinder head cover according to the invention,

FIG. 4 a sectional representation through an internal combustion engine according to the invention in the region of a cylinder head cover and of a cylinder head.

### DETAILED DESCRIPTION

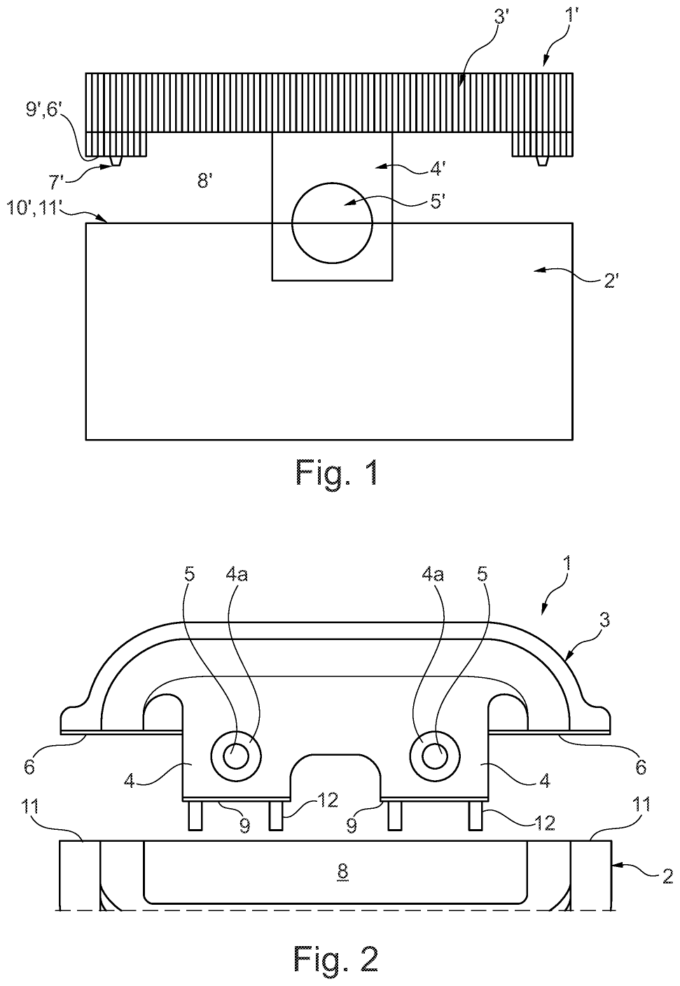

According to FIG. 1, a conventional internal combustion engine 1′ comprises a cylinder head 2′ and a cylinder head cover 3′, wherein on the cylinder head cover 3′ a camshaft 5′ is mounted via a bearing 4′. Here, first sealing surfaces 6′ with a seal 7′ are provided on the cylinder head cover 3′, wherein on the cylinder head 2′ associated second sealing surfaces 11′ are arranged, which with the cylinder head cover 3′ mounted on the cylinder head 2′, seal a camshaft space 8′ to the surroundings via the seal 7′. In order to be able to achieve here an exact alignment of the cylinder head cover 3′ relative to the cylinder head 2′, the first sealing surfaces 6′ on the cylinder head cover 3′ are simultaneously formed as first reference surfaces 9′, while the second sealing surfaces 11′ arranged on the cylinder head 2′ simultaneously serve as second reference surfaces 10′.

Since on the cylinder head cover 3′ the camshaft 5′ is also mounted via the bearings 4′, an exact alignment of a camshaft axis relative to a cam-follower axis on the cylinder head 2′ which is not designated in more detail is required in order to be able to achieve in particular a low-friction operation of a valve drive and thus a reduced noise emission and a reduced fuel consumption. Here, the first and second reference surfaces 9′, 10′ serve for the exact alignment of the cylinder head cover 3′ relative to the cylinder head 2′ which therefore have to be formed extremely exactly, in particular also reworked. Since with the internal combustion engine 1′ known from the prior art the first and second reference surfaces 9′, 10′ also serve as sealing surfaces 6′, 11′ at the same time, a particularly high dimensional accuracy is required in order to be able to ensure on the one hand the tightness and on the other hand the exact alignment. Through the low tolerable dimensional inaccuracies in the region of the sealing surfaces 6′, 11′ serving as reference surfaces 9′, 10′, the production both of the cylinder head 2′ and also of the cylinder head cover 3′ is comparatively involved and expensive.

The solution according to the invention is now described in the following, wherein same reference numbers relate to same components but which, in the solution according to the invention, are designated without apostrophe.

According to FIGS. 2 to 4, likewise at least one first sealing surface 6 is provided on the cylinder head cover 3 according to the invention shown there for covering a cylinder head 2 of an internal combustion engine 1, via which sealing surface 6 the cylinder head cover 3 can be tightly connected to an associated second sealing surface 11 on the cylinder head 2. At least one first reference surface 9 for the unambiguous position-fixing and thus alignment relative to the cylinder head 2 is additionally provided on the cylinder head cover 3 or on at least one associated second reference surface 10 of the cylinder head 2. According to the invention, the at least one first reference surface 9 and the at least one first sealing surface 6 is now formed on the cylinder head cover 3 separately from one another, as a result of which an alignment function and a sealing function can likewise be decoupled from one another.

In the same manner, a second reference surface 10 for the unambiguous position-fixing on the associated first reference surface 9 of the cylinder head cover 3 is now formed on the cylinder head 2 separately from the at least one second sealing surface 11 also with the cylinder head 2 (see FIG. 4) according to the invention. By way of this a working with greater tolerances or complete omission of a working of the first and/or second sealing surface 6, 11 is possible since these sealing surfaces 6, 11 are now no longer decisive for the exact alignment of the cylinder head cover 3 relative to the cylinder head 2 and thus for the exact alignment of the camshaft 5 or of the camshaft axis of the same relative to a cam-follower axis on the cylinder head 2.

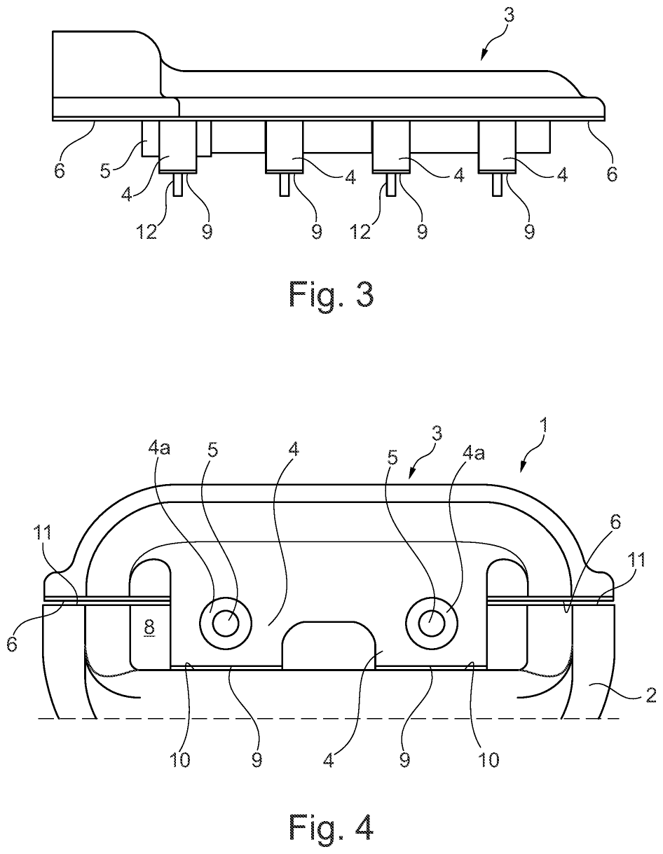

Looking at the cylinder head cover 3 according to FIGS. 2 and 3 further, it is noticeable that in the region of the first reference surface 9 screws 12 are provided, so that a fixing of the cylinder head cover 3 on the cylinder head 2 takes place via screws 12 directly arranged on the first reference surfaces 9 and thus close to the bearing, which is a major advantage in particular for absorbing greater engine forces.

Looking at the first reference surfaces 9 compared with the first sealing surface 6 on the cylinder head cover 3 and also at the second reference surfaces 10 with reference to the second sealing surface 11 on the cylinder head 2 it is noticeable that the at least one first reference surface 9 is smaller than the at least one first sealing surface 6 and to the same extent the at least one second reference surface 10 is also smaller than the at least one second sealing surface 11. By way of this it can be achieved that a large-area working of the sealing surfaces 6 and 11 required to date can be omitted and merely the reference surfaces 9, 10 that are significantly smaller relative to this still have to be worked if required, which saves both working time and also working expenditure. Here, a sum of all first reference surfaces 9 can also be smaller than a sum of all first sealing surfaces 6. Likewise, a sum of all second reference surfaces 10 can also be smaller than a sum of all second sealing surfaces 11.

Looking at the cylinder head cover 3 further it is noticeable that on the same at least two bearings 4 for a camshaft 5, here even two camshafts 5 are provided, wherein on at least one of these bearings 4 an associated first reference surface 9 is arranged. Here, the at least two bearings 4 can be part of a bearing frame connected to the cylinder head cover 3 or formed integrally with the same, as a result of which it becomes possible to form the bearing frame out of a material, for example metal, in particular aluminium, distinct from the cylinder head cover 3, which can then be formed for example as a plastic injection-moulding. Here, the bearings 4 can be designed as split-bearing or as one-piece bearing.

Generally it is also conceivable that the cylinder head cover 3 is formed as a plastic injection-moulding, wherein in this case the at least two bearings 4 comprise bearing rings for a or bearings shells, in particular of aluminium, which are injection-moulded into the plastic of the cylinder head cover 3.

According to FIGS. 2 and 4, the first sealing surface 6 is arranged parallel or orthogonally to the surface spaced apart from the at least one reference surface 9, so that the first sealing surface 6 according to FIGS. 2 to 4 is situated higher than the first reference surfaces 9. In the shown embodiments, the first sealing surface 6 is additionally formed flat, wherein the same can obviously comprise alternatively also a sealing groove for receiving a seal which is not shown. On the same manner, the second sealing surface 11 arranged on the cylinder head 2 can also be designed flat or with a sealing groove for receiving a seal. Generally, curved first reference surfaces 9 and associated curved second reference surfaces 10 formed complementarily are also conceivable, which make possible a positive interlocking and thus an exact alignment of the cylinder head cover 3 relative to the cylinder head 2.

Generally, the cylinder head cover 3 can be formed as a metallic die-casting for example of aluminium or as an injection-moulding, wherein on the cylinder head cover 3 at least one opening for installing a function part, such as for example a position sensor, a pump or an oil mist separator or for filling-in oil can be additionally arranged.

In a particularly advantageous embodiment of the solution according to the invention, at least two first reference surfaces 9 inclined towards one another can also be arranged on the cylinder head cover 3, wherein in the same manner second reference surfaces 10 inclined towards one another and formed complementarily thereto can also be arranged on the cylinder head 2. By way of this, a particularly simple exact since positive-locking alignment and mounting of the cylinder head cover 3 on the cylinder head 2 is possible.

On its at least one first reference surface 9, the cylinder head cover 3 can be screwed, glued, riveted or connected by way of dowels to an associated second reference surface 10 of the cylinder head 2. Such dowels can enforce a further comparatively easy predefined position of the cylinder head cover 3 relative to the cylinder head 2 and thereby simplify the mounting.

Between the first sealing surface 6 and the second sealing surface 11, an elastomer seal, a paper gasket, a liquid seal or a metal gasket can be arranged for example, wherein the two sealing surfaces 6, 11, because of the reference surfaces 9, 10 decoupled from these, need not be reworked or less intensively so since for example by way of an elastomer seal higher dimensional tolerances can compensated for without problems.

With the internal combustion engine 1 according to the invention having the cylinder head 2 according to the invention and the cylinder head cover 3 according to the invention a decoupling of reference surfaces 9, 10 aligning the cylinder head cover 3 relative to the cylinder head 2, from the associated sealing surfaces 6, 11 is possible for the first time, as a result of which a simpler and more cost-effective as well as also an extremely exact production of the internal combustion engine 1 is possible. Because of the circumstance that the reference surfaces 9, 10 compared with the associated sealing surfaces 6, 11 are significantly smaller and the latter do not have to be reworked or only marginally so, a reworking in the most favourable of cases can remain limited to the reference surfaces 9, 10 as a result of which a significantly reduced reworking effort materialises.

1. A cylinder head cover for covering a cylinder head of an internal combustion engine having at least one first sealing surface via which the cylinder head cover can be tightly connected to an associated second sealing surface on the cylinder head, the cylinder head cover, comprising:
at least one first reference surface configured for unambiguous position-fixing on an associated second reference surface of the cylinder head;
wherein the at least one first reference surface and the at least one first sealing surface are formed separately from one another.

2. The cylinder head cover according to claim 1, wherein:
the at least one first reference surface is smaller than the at least one first sealing surface; and/or
a sum of all first reference surfaces is smaller than a sum of all first sealing surfaces.

3. The cylinder head cover according to claim 1,
wherein on the cylinder head cover at least two bearings for a camshaft are provided, and wherein on at least one bearing a first reference surface is arranged.

4. The cylinder head cover according to claim 3,
wherein the at least two bearings are part of a bearing frame that is connected to the cylinder head cover or formed integrally with the same.

5. The cylinder head cover according to claim 1, wherein:
the at least one first sealing surface is arranged parallel and spaced apart from the at least one first reference surface; and/or
the at least one first sealing surface is flat or comprises a sealing groove for receiving a seal.

6. The cylinder head cover according to claim 1, wherein:
the cylinder head cover is formed as a metallic die-casting; and/or
the cylinder head cover includes at least one opening configured for installing a function component, the function component comprising one among a position sensor, a pump or an oil mist separator or for filling-in oil.

7. The cylinder head cover according to claim 3,
wherein the cylinder head cover is formed as a plastic injection-moulding, and wherein the at least two bearings comprise bearing rings which are injection-moulded into the plastic of the cylinder head cover.

8. The cylinder head cover according to claim 1, wherein:
the cylinder head cover comprises at least two first reference surfaces that are inclined towards one another; and/or
at least one first reference surface is designed curved.

9. A cylinder head of an internal combustion engine, comprising:
at least one second sealing surface;
at least one associated first sealing surface of a cylinder head cover;
wherein on the cylinder head, at least one second reference surface configured for unambiguous position-fixing on an associated first reference surface of the cylinder head cover is provided; and
wherein the at least one second reference surface and the at least one second sealing surface are formed separately from one another.

10. The cylinder head according to claim 9, wherein:
the at least one second reference surface is smaller than the at least one second sealing surface; and/or
a sum of all second reference surfaces is smaller than a sum of all second sealing surfaces.

11. The cylinder head according to claim 9,
wherein the at least one second sealing surface is arranged parallel and spaced apart from the at least one second reference surface.

12. The cylinder head according to claim 9, wherein
the cylinder head comprises at least two second reference surfaces that are inclined towards one another; and/or
at least one second reference surface is designed curved.

13. An internal combustion engine, comprising:
a cylinder head according to claim 9; and
a cylinder head cover connected to the cylinder head according to claim 1.

14. The internal combustion engine according to claim 13, wherein:
the at least one first reference surface on the cylinder head cover is screwed, glued, riveted and/or connected by way of dowels to an associated second reference surface on the cylinder head; and/or
between the at least one first sealing surface and the associated at least one second sealing surface an elastomer seal, a paper gasket, a liquid seal or a metal gasket is arranged.

15. The internal combustion engine according to claim 13, wherein:
the cylinder head cover comprises at least two first reference surfaces that are inclined towards one another;
on the cylinder head, at least two inclined second reference surfaces formed complementarily to the inclined first reference surfaces arranged on the cylinder head cover are arranged;
the cylinder head cover and the cylinder head are positively connected to one another via the at least two first and second reference surfaces.

16. The cylinder head cover according to claim 1, wherein the cylinder head cover is formed of aluminium.

17. The cylinder head cover according to claim 1, wherein the cylinder head cover is formed of a plastic injection-moulding.

18. The cylinder head cover according to claim 7, wherein the at least two bearings comprise aluminium and are injection-moulded into the plastic of the cylinder head cover.

19. The cylinder head cover according to claim 1, wherein the at least one first reference surface is smaller than the at least one first sealing surface.

20. The cylinder head cover according to claim 1, wherein a sum of all first reference surfaces is smaller than a sum of all first sealing surfaces.
